(19) United States
(12) Patent Application Publication
(10) Pub. No.: US 2024/0393138 A1
(43) Pub. Date: Nov. 28, 2024

(54) POSITION SENSOR FOR A CAMSHAFT, CAMSHAFT ARRANGEMENT, AND METHOD

(71) Applicant: MAHLE International GmbH, Stuttgart (DE)

(72) Inventors: Christoph Steinmetz, Ludwigsburg (DE); Tilo Hentschel, Hattenhofen (DE)

(21) Appl. No.: 18/673,305

(22) Filed: May 23, 2024

(30) Foreign Application Priority Data
May 24, 2023 (DE) 10 2023 204 847.7

(51) Int. Cl. G01D 5/14; G01B 7/30

(52) U.S. Cl. CPC G01D 5/145; G01B 7/30

(57) ABSTRACT

A position encoder for a camshaft is disclosed. The position encoder includes an annular base body arranged in a base plane and having a central longitudinal axis extending vertically in relation to the base plane along an axial direction. At least one signal tab projecting radially outward integrally formed on an outer circumference of the base body. One recess respectively is provided at a transition to the bent signal section on two sides delimiting the signal tab in the circumferential direction. An axial end face of the bent signal section of the signal tab tapers at least in a tapered section in a longitudinal section along the axial direction, from radially outwards to radially inwards toward the base body.

### CROSS-REFERENCE TO RELATED APPLICATIONS

This application claims priority to German Patent Application No. DE 102023204847.7 filed on May 24, 2023, the contents of which are hereby incorporated by reference in its entirety.

### TECHNICAL FIELD

The invention relates to a position encoder for a camshaft and a camshaft arrangement with such a position encoder. The invention further relates to a method for producing such a position encoder.

### BACKGROUND

Modern camshafts are equipped with position encoders that allow a determination of a current rotation angle position of the camshaft. Such position encoders typically have an annular base body that is pushed onto the camshaft and connected to the latter rotationally fixed. At least one signal tab that follows a rotation of the camshaft about its axis of rotation and can, for example, be bent toward the axis of rotation, projects radially outward from the base body. The current position of the position encoder and thus also of the camshaft as well as the direction of rotation of the camshaft is detected by means of a stationary sensor, i.e., a sensor not following the rotary movement of the camshaft, for example a Hall sensor in the form of a change of the Hall voltage, and is analyzed by a connected control device.

In order to produce such a position encoder, the base body can be punched out of a sheet metal part with the signal tab projecting radially outward and can then be bent toward the central longitudinal axis defining the later axis of rotation.

It has been shown to be problematic that the material displacement resulting from the bending at the transition from the base body to the signal tab can have a negative effect on the signal detection as a geometry projecting from the actual signal edge when the position encoder is operated. This in turn can lead to a reduction in the position accuracy with which the position encoder can determine the current rotational position.

It is therefore an object of the present invention to create an improved embodiment for a position encoder described above, wherein the problem mentioned above either no longer exists or only exists to a reduced extent. Furthermore, an improved manufacturing method for producing such a camshaft is to be created.

This object is achieved by the scope of the independent claim(s). Preferred embodiments are the scope of the dependent claims.

### SUMMARY

The basic idea of the invention is therefore to provide at least one signal tab projecting outward from the base body with a radially outer signal section that is bent toward the axial direction of the base body and to provide two recesses at the transition to the radial signal section of the signal tab that are positioned opposite each other in the circumferential direction of the base body. The invention also proposes that an axial end face of the signal section of the signal tab is adapted such that it tapers from radially outer to radial inner toward the central longitudinal axis of the base body. The two measures mentioned in combination allow a reduction in the thickness of the signal tab. Compared to conventional position encoders, this in turn causes a more precise influence on the generated Hall voltage, thus increasing the precision with which the current rotational position of the position encoder can be deter-mined.

Specifically, an inventive position encoder for a camshaft comprises an annular base body arranged in a base plane, said base body comprising a central longitudinal axis extending vertically along an axial direction to the base plane. On the outer circumference of the base body, at least one signal tab is integrally formed radially on the outside, said signal tab extending circumferentially along a circumferential direction about the central longitudinal axis over a circumferential angle and is bent in a radially outer signal section toward the axial direction. The base body and the at least one signal tab are thus formed integrally and from a single material. According to the invention, one recess each is provided in the signal tab at the transition to the signal section on two sides delimiting the signal in the circumferential direction. According to the invention, an axial end face of the bent signal tab also tapers in a longitudinal section along the axial direction and/or parallel to the axial direction in a radially extended section tapering from radially outwards to radially inwards toward the base body. A thickness of the main body measured along the axial direction can preferably be between 1 mm and 3 mm, particularly preferably approximately 2 mm.

Particularly preferably, the signal tab projects radially outward from the main body. This allows a simple punching out or cutting out of the base body and the signal tab, including the two recesses essential for the invention, in a common and thus single work step.

Particularly preferably, the tapering of the axial face side can be formed by an undercut, which preferably has an angle between 0.5° and 5°. Alternatively or additionally, an extension section extending vertically in relation to the axial direction can adjoin the tapered section radially outward in the longitudinal section. This variant is particularly easy to produce and therefore also particularly cost-effective to manufacture.

The two recesses can be particularly expediently opposite each other along the circumferential direction. This avoids a disadvantageous accumulation of material at the transition from the base body to the signal tab-caused by the bending of the signal tab.

According to an advantageous further embodiment of the inventive position encoder, at least one of the two sides with the recess essential for the invention extends along a radial direction of the base body. This applies particularly preferably to both sides.

Another preferred embodiment provides that the signal section with the two recesses can be arranged radially at a distance from the outer circumference of the annular base body.

A depth measured along the circumferential direction of at least one recess, preferably both recesses, corresponds particularly expediently to at least ¼ of a thickness of the base body measured along the axial direction.

The base body can expediently be a formed sheet metal part. This allows a simple punching or cutting out of the base body and signal tab from a blank and a bending of the signal tab following the punching out.

According to a further advantageous further embodiment of the inventive position encoder, at least two, preferably several, signal tabs are arranged at a distance from one another along the circumferential direction. Thus, the person skilled in the art can determine the most advantageous number of signal tabs for the respective application for determining the position on an application-specific basis.

The invention further relates to a camshaft arrangement with a camshaft that can be rotated about an axis of rotation and with a position encoder—as presented above and thus according to the invention-arranged rotationally fixed on an outer circumference of the camshaft. The camshaft arrangement further comprises a sensor cooperating with the position encoder for determining a momentary rotational position of the camshaft. The sensor does not follow the rotary movement of the camshaft such that the position encoder rotates relative to the sensor. The advantages of the inventive position encoder explained above apply likewise to the inventive camshaft arrangement. The sensor can preferably be a Hall sensor.

The invention further relates to a method for producing a position encoder for a camshaft, in particular an inventive position encoder presented above such that in this case the advantages of the inventive position encoder also apply likewise to the inventive method.

The inventive method comprises three measures a) to c).

Measure a) provides an annular blank arranged in a base plane, said blank having a central longitudinal axis extending perpendicular to the base plane along an axial direction. The blank can be a sheet-metal strip.

Measure b) forms the base body from the blank by punching out or cutting out the at least one signal tab. The signal tab is punched out or cut out such that the outer circumferential side of the formed signal tab tapers along the axial direction. According to measure c), a radially outer signal section of the signal tab is bent toward the axial direction such that the outer circumference of the signal section of the signal tab tapering inward in axial direction prior to bending forms an end face of the bent signal tab after bending. According to the invention, one recess each is incorporated at the transition to the later signal section, on two sides delimiting the signal tab in circumferential direction, either in the course of action b) or chronologically before performing action b).

Particularly expediently, the at least one signal tab is punched out or cut out in measure b) by means of a punching process or a cutting process, in particular by means of laser cutting or water jet cutting.

According to an advantageous further embodiment, the inventive method can comprise an additional measure a0) that precedes the measure a). According to this additional measure a0), the blank having an annular geometry according to measure a) is first provided as a disc-shaped blank with a circular geometry. According to measure a0), a concentric circular cutout is incorporated concentrically into the blank with circular geometry. As a result, the originally circular blank has an annular geometry after said cutout is incorporated.

Particularly preferably, the two recesses can be produced on the signal tab in the course of the measure a0). This significantly simplifies the entire manufacturing process.

At least the measures a) to c), preferably also the measure a0 described above, can particularly preferably be carried out in a progressive forming tool. This enables cost-effective mass production of the position encoder.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

They show, schematically in each case,

FIG. 1 a position encoder according to the invention in a perspective illustration,

FIG. 2 the position encoder of FIG. 1 in an axial plan view,

FIG. 3 a signal tab in the region of its bent signal section in a longitudinal section along the axial direction.

FIG. 4 a flow chart illustrating the method according to the invention,

FIG. 5 a plan view onto the base body along the axial direction in the region of a single signal tab after punching out or cutting out the signal tab, but before bending the signal section,

FIG. 6 a sectional view illustrating the bending of the signal section of the signal tab.

### DETAILED DESCRIPTION

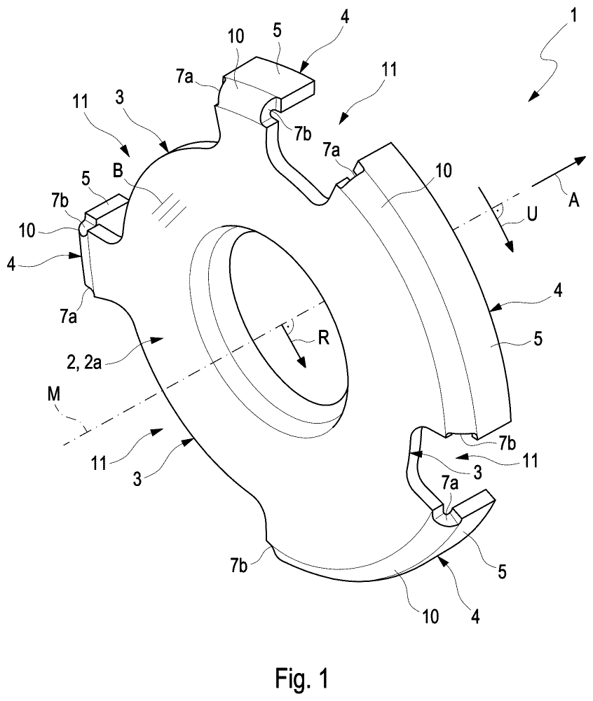

FIG. 1 shows an example of an inventive position encoder 1 for a camshaft (not shown) in a perspective illustration. The position encoder 1 comprises an annular base body 2 arranged in a base plane B, said base body 2 having a central longitudinal axis M extending orthogonally to the base plane B along an axial direction A. A radial direction R extends vertically in relation to the axial direction A away from the central longitudinal axis M. A circumferential direction U extends about the central longitudinal axis M vertically in relation to the axial direction A and also in relation to the radial direction R.

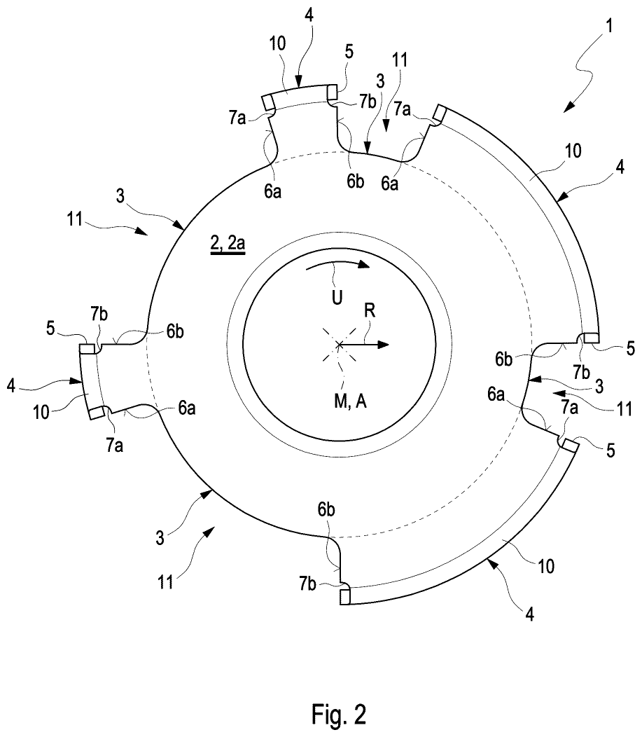

FIG. 2 shows the position encoder 1 of FIG. 1 in a plan view along the axial direction A.

The base body 2 can be a formed sheet metal part 2a. According to FIGS. 1 and 2, a plurality of signal tabs 4 are integrally formed at a distance from one another on the outer circumference 3 of the base body 2 along the circumferential direction U. The individual signal tabs 4 are arranged radially on the outside of the outer circumference 3 of the base body 2 and each project radially outward from the base body 2. A radial recess 11 is formed between two signal tabs 4 adjacent in the circumferential direction U, i.e., signal tabs 4 and recesses 11 alternate successively along the circumferential direction U. Each of the signal tabs 4 extends along the circumferential direction U over a predetermined circumferential angle and is bent in a radially outer signal section 5 toward the axial direction A.

As can be seen in particular in FIG. 2, the two sides 6a, 6b with the recesses 7a, 7b extend from the base body 2 to the transition 10 or to the respective recess 7a or 7b along the radial direction R of the base body 2. The respective signal section 5 with the two recesses 7a, 7b is arranged in radial direction R at a distance from the outer circumference 3 of the annular base body 2. In a transition 10 of the signal tab 4 to the bent radially outer signal section 5, one recess 7a, 7b each is provided on two sides 6a, 6b delimiting the respective signal tab 4 in the circumferential direction U. The two recesses 7a, 7b are opposite each other along the circumferential direction U. A depth of the two recesses 7a, 7b measured along the circumferential direction U is respectively at least ¼ of a thickness of the base body 2 as measured along the axial direction A.

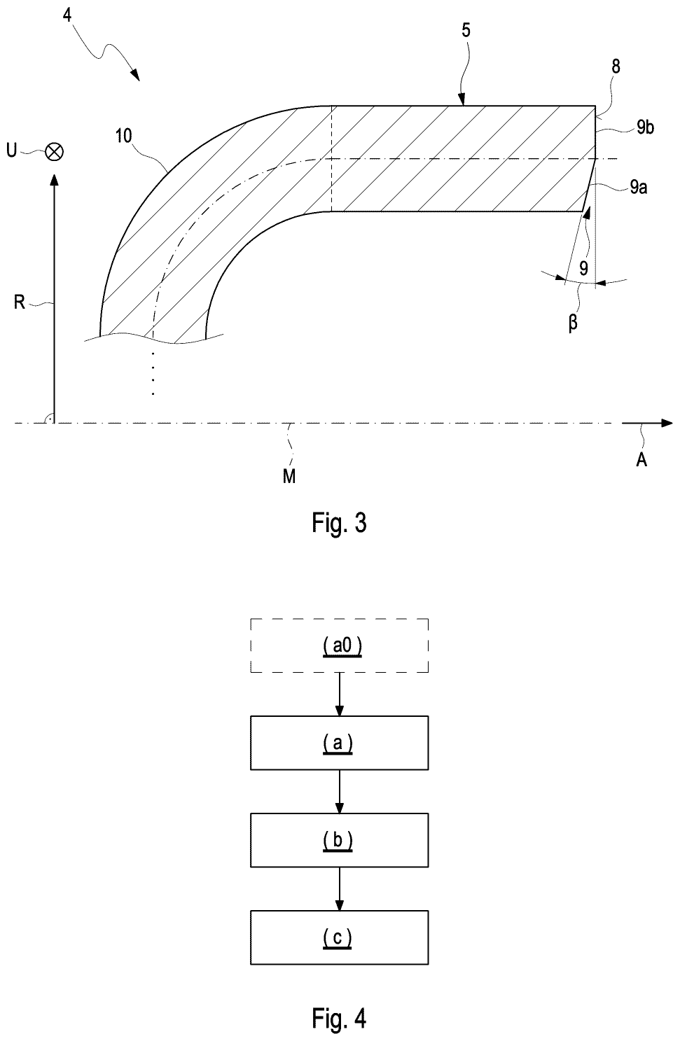

FIG. 3 shows a signal tab 4 in the area of its bent signal section 5 in a longitudinal section along the axial direction A. An axial end face 8 of the radially outer signal section 5 of the bent signal tab 4 is tapered in the longitudinal section, shown in a tapered section 9a extending along the radial direction R, along the radial direction R from radially outer to radially inner toward the base body 2 (not shown in FIG. 2). Said tapering of the axial end face 8 is formed by an undercut 9, which preferably has an angle β between 0.5° and 5°. An extension section 9b can adjoin the tapered section 9a radially on the outside without tapering, said extension section 9b consequently extending along the radial direction R and thus orthogonally to the axial direction A.

The position encoder 1 explained above can be part of an inventive camshaft arrangement (not shown in the figures) that has a camshaft adapted to rotate about an axis of rotation and an inventive position encoder 1 UF arranged rotationally fixed on an outer circumference of the camshaft. The camshaft arrangement further comprises a sensor (not shown), in particular a Hall sensor, cooperating with the position encoder 1 for determining a current rotational position of the camshaft. The sensor does not follow the rotary movement of the camshaft such that the position encoder 1 rotates relative to the sensor.

FIG. 4 shows a flow chart on the basis of which the inventive method for producing the inventive position encoder 1 for a camshaft is explained below.

In the example, the inventive method comprises three mandatory measures a) to c) as well as an optional additional measure a0 chronologically preceding the measure a).

According to the optional and additional measure a0), a disk-shaped blank is provided with circular geometry along the axial direction in a plan view. The blank can be a sheet-metal strip. The three-dimensional geometric shape of the blank thus corresponds to that of a cylinder. Likewise, in measure a0), a circular cutout is incorporated concentrically into the blank with circular geometry. As a result, the originally circular blank has an annular geometry after said cutout is incorporated. The blank is shaped as required by measure a) after performing the measure a0).

In measure b), the blank is formed by punching out or cutting out the base body 2 with the signal tabs 4. The signal tabs 4 are punched out or cut out from the blank in measure b) by means of a punching process or a cutting process, in particular by means of laser cutting or water jet cutting. Four example signal tabs 4 are generated In the example of the figures. The individual signal tabs 4 are cut out or punched out such that the outer circumferential side 12 of the formed signal tab 4 tapers along the axial direction A.

The punched or cut-out parts of the blank can be removed such that radial recesses 11 are created between signal tabs 4 adjacent in the circumferential direction U (cf. FIGS. 1, 2). However, the punched or cut-out parts of the blank can also remain on the blank until the signal tabs 4 have yet to be bent, which can in particular prove advantageous if the inventive method is carried out in a progressive forming tool with a plurality of workstations.

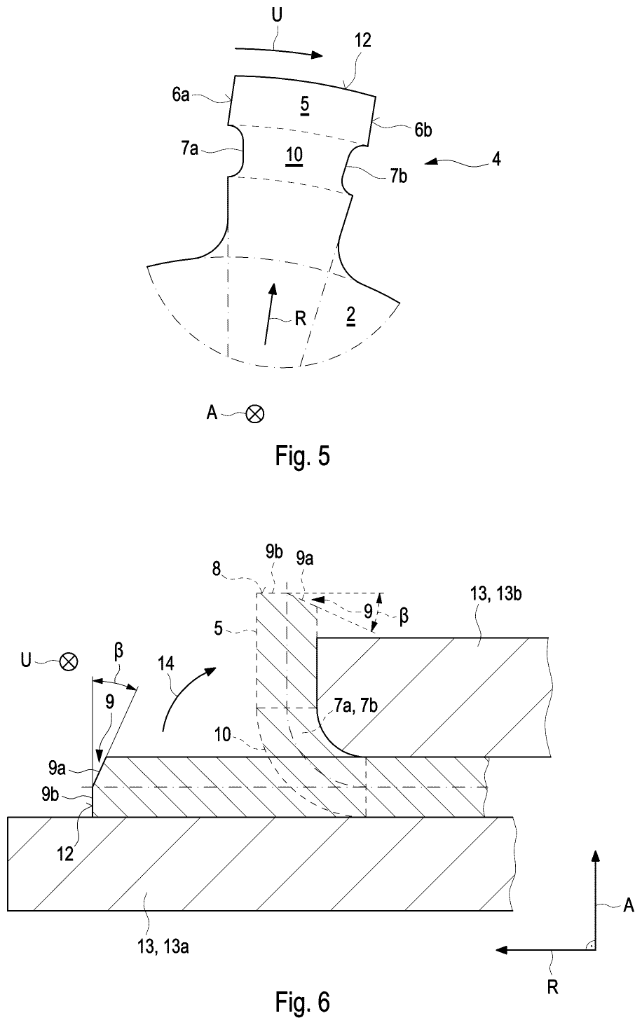

According to a further measure c), a radially outer signal section 5 of the signal tab 4 (cf. FIG. 5) is bent toward the axial direction A. FIG. 6 shows a section through the signal tab 4 of FIG. 5 illustrating this bending of the signal section 5 in a sectional plane spanned by the radial direction R and the axial direction A. FIG. 6 shows the signal tab 4 before and after bending. The bending can be achieved by means of a bending tool 13 only schematically indicated in FIG. 6 and that can comprise a pressure plate 13a and a bending support 13b. The bending is indicated in FIG. 6 by an arrow marked with the reference symbol 14.

The outer circumferential side 12 of the signal section 5 of the signal tab 4, which tapers before bending along the axial direction A, forms a face 8 of the bent signal tab 4 after bending, which now tapers radially inward toward the base body 2.

As can be seen in FIGS. 5 and 6, in the course of action b) or chronologically before the execution of action b)—in the latter case, for example in the measure a0) described above-one recess 7a, 7b each is incorporated at the transition to the later signal section (5) along two sides 6a, 6b that each delimit the signal tab 4 in the circumferential direction U.

In the example scenario, the three mandatory measures a) to c) as well as the optional measure a0) can be carried out in a progressive forming tool.

1. A position encoder for a camshaft, comprising:
an annular base body arranged in a base plane and having a central longitudinal axis extending vertically in relation to the base plane along an axial direction,
at least one signal tab projecting radially outward integrally formed on an outer circumference of the base body and extending circumferentially about the central longitudinal axis along a circumferential direction about a predetermined circumferential angle and is bent in a radially outer signal section in relation to the axial direction,
wherein respectively one recess each is provided at a transition to the bent signal section on two sides delimiting the at least one signal tab in the circumferential direction,
wherein, an axial end face of the bent signal section of the at least one signal tab tapers at least in a tapered section in a longitudinal section along the axial direction, from radially outwards to radially inwards toward the base body.

2. The position encoder according to claim 1, wherein the at least one signal tab projects radially outward from the base body.

3. The position encoder according to claim 1, wherein the tapering of the axial end face is formed in the tapered section by an undercut.

4. The position encoder according to claim 1, wherein an extension section extending perpendicular to the axial direction adjoins the tapered section radially on the outside in the longitudinal section.

5. The position encoder according to claim 1, wherein the two recesses are opposite each other along the circumferential direction.

6. The position encoder according to claim 1, wherein at least one of the two sides extends at least from the base body to the respective recess along a radial direction of the base body.

7. The position encoder according to claim 1, wherein a depth measured along the circumferential direction of at least one recess amounts to at least ¼ of a thickness of the base body as measured along the axial direction.

8. The position encoder according to claim 1, wherein the base body is a formed sheet metal part.

9. The position encoder according to claim 1, wherein at least two signal tabs are arranged at a distance from one another along the circumferential direction.

10. A camshaft arrangement, comprising:
a camshaft that rotates about an axis of rotation,
a position encoder arranged rotationally fixed on an outer circumference of the camshaft, the position encoder including:
an annular base body arranged in a base plane and having a central longitudinal axis extending vertically in relation to the base plane along an axial direction,
at least one signal tab projecting radially outward integrally formed on an outer circumference of the base body and extending circumferentially about the central longitudinal axis along a circumferential direction about a predetermined circumferential angle and is bent in a radially outer signal section in relation to the axial direction,
wherein respectively one recess each is provided at a transition to the bent signal section on two sides delimiting the signal tab in the circumferential direction,
wherein, an axial end face of the bent signal section of the signal tab tapers at least in a tapered section in a longitudinal section along the axial direction, from radially outwards to radially inwards toward the base body, and
a sensor cooperating with the position encoder for determining a momentary rotational position of the camshaft.

11. A method for producing a position encoder for a camshaft, comprising the following steps:
a) provide an annular blank arranged in a base plane that has a central longitudinal axis extending perpendicular to the base plane along an axial direction,
b) forming the base body from the blank by punching out or cutting out at least one signal tab protecting radially outward from an outer circumference of the base body, wherein the punching out or cutting out takes place such that an outer circumferential side of the at least one signal tab tapers along the axial direction,
c) bending a radially outer signal section of the at least one signal tab toward the axial direction such that the outer circumferential side of the signal section of the at least one signal tab that tapers inwards radially toward the base body before bending forms an end face of the bent signal tab that tapers radially inwards after bending,
wherein, one recess each is incorporated at a transition to the signal section on two sides delimiting the at least one signal tab in the circumferential direction, either in the course of measure b) or chronologically prior to performing measure b).

12. The method according to claim 11, wherein the punching out or cutting out of the at least one signal tab in measure b) is performed via a punching process or a cutting process.

13. The method according to claim 11, further comprising the following measure a0) chronologically preceding measure a:
a0) provide the blank with a circular geometry and incorporate a concentric circular cutout into the blank such that the blank has an annular geometry after incorporation.

14. The method according to claim 13, wherein the two recesses are formed on the at least one signal tab in the course of the measure a0).

15. The method according to claim 11, wherein at least the measures a) to c), are carried out in a progressive forming tool.

16. The camshaft arrangement according to claim 10, wherein the at least one signal tab projects radially outward from the base body.

17. The camshaft arrangement according to claim 10, wherein the tapering of the axial end face is formed in the tapered section extending perpendicular to the axial direction adjoins the tapered section radially on the outside in the longitudinal section.

18. The camshaft arrangement according to claim 10, wherein an extension section extending perpendicular to the axial direction adjoins the tapered section radially on the outside in the longitudinal section.

19. The camshaft arrangement according to claim 10, wherein the two recesses are opposite each other along the circumferential direction.

20. The position encoder according to claim 3, wherein the undercut has an angle between 0.5° and 5°.
